(19) United States
(12) Patent Application Publication
(10) Pub. No.: US 2013/0216263 A1
(43) Pub. Date: Aug. 22, 2013

(54) IMAGE FORMING APPARATUS

(71) Applicant: CANON KABUSHIKI KAISHA, (US)

(72) Inventors: Tomoaki Miyazawa, Tokyo (JP); Kenta Kubo, Kamakura-shi (JP); Tomohito Ishida, Saitama-shi (JP); Shuji Moriya, Yokohama-shi (JP); Hirokazu Usami, Kawasaki-shi (JP); Juun Horie, Tokyo (JP); Manami Haraguchi, Yokohama-shi (JP); Takeshi Yamamoto, Yokohama-shi (JP)

(73) Assignee: CANON KABUSHIKI KAISHA, Tokyo (JP)

(21) Appl. No.: 13/765,962

(22) Filed: Feb. 13, 2013

(30) Foreign Application Priority Data
Feb. 17, 2012 (JP) 2012-032551

(51) Int. Cl. G03G 15/00; G03G 15/09

(52) U.S. Cl. CPC G03G 13/08
USPC 399/167; 399/270; 399/236; 399/267

(57) ABSTRACT

An image forming apparatus includes: an image bearing member; an electrostatic image forming device; and a developer carrying member. The developer carrying member is provided so as to be rotated in a direction opposite to a rotational direction of the image bearing member at a peripheral speed higher than that of the image bearing member. When the peripheral speed of the image bearing member is Vp (m/sec), the peripheral speed of the developer carrying member is Vs (m/sec), and a time, of movement of the developer from the surface of the developer carrying member to the image bearing member, actually measured in a gap between the image bearing member and the developer carrying member is Tsd (sec), the peripheral speeds Vp and Vs and the time Tsd satisfy the following relationship: (Vs−Vp)×Tsd<3×10⁵ (m).

### FIELD OF THE INVENTION AND RELATED ART

The present invention relates to an image forming apparatus for developing an electrostatic image on an image bearing member into a toner image by applying an oscillating voltage to a developer carrying member rotating at a peripheral speed higher than that of the image bearing member. Specifically, the present invention relates to an operating condition in which a trailing end improper development is suppressed by using a parameter obtained by actually measuring behavior of individual toner particles.

The image forming apparatus in which the electrostatic image formed on the image bearing member is developed into the toner image by a developing device and the toner image is transferred, directly or via an intermediary transfer member, from the image bearing member onto a recording material, and then the recording material on which the toner image is transferred is heated and pressed by a fixing device (apparatus) to fix an image thereon, has been widely used. Also an image forming apparatus of a two-component development type in which a developer principally containing a toner and a carrier is used when the electrostatic image is developed into the toner image has been used widely.

As shown in FIG. 1, in the two-component development type, in general, in a state in which the toner and the carrier are reversely charged and thus the toner is deposited on the carrier, the developer is magnetically attracted on a developer carrying member 41 of the developing device to form a magnetic chain thereof in a developing region G as an opposing portion where the developer carrying member 41 opposes an image bearing member 1. In a state in which the magnetic chain rubs (slides on) the surface of the image bearing member 1 in the developing region G, by applying to the developer carrying member 41 an oscillating voltage in the form of a predetermined DC voltage biased with a predetermined AC voltage, the toner of the magnetic chain is transferred onto the electrostatic image on the image bearing member 1.

As shown in FIG. 5, in the two-component development type, in some cases, a phenomenon which is called a trailing end improper development such that a toner amount per unit area at a trailing end portion (final development portion) of a halftone image is lowered is generated. The trailing end improper development has been conventionally considered as being generated due to a phenomenon that the magnetic chain on the developer carrying member 41 rotating at a speed higher than that of the image bearing member 1 in the same direction as that of the image bearing member 1 follows the toner developed from the electrostatic image to scrape off the toner.

In Japanese Laid-Open Patent Application (JP-A) 2003-323051, on the basis of an interpretation of such toner behavior, by adding a magnetic pole in a developing region G of a magnet 42 provided inside a developer carrying member 41, a magnetic chain having a distribution shape such that scraping-off of the toner is not readily generated is formed.

In a developing device in JP-A 2003-323051, a special magnet 42 to which the magnetic pole is added in the developing region G is needed. The added magnetic pole not only complicates a structure of the magnet but also weaken a magnetic force of original magnetic poles. For that reason, there is a need to modify various image forming conditions (voltage, rotational speed and the like).

Incidentally, as described later, when a simulation apparatus of the developing region is prepared and then the magnetic chain in the developing region is shot at high speed and is replayed in slow motion, a new knowledge about the toner behavior in the developing region G was obtained. Even under application of an oscillating voltage in the form of a DC voltage biased with an AC voltage close to 2 (kV) in peak-to-peak voltage, the toner carried on the magnetic chain was influenced by a potential of the electrostatic image formed on the image bearing member, so that a fluctuation of a toner distribution was generated with respect to an opposing direction between the developer carrying member 41 and the image bearing member 1. That is, with respect to the magnetic chain rubbing a non-image forming portion located rearward than a trailing end of the image, the toner is averagely moved toward a base portion of the magnetic chain, and it was observed that the toner carried by the magnetic chain was insufficient at the time when the magnetic chain caught up with the trailing end of the image with rotation of the developer carrying member. Further, it was also observed that an average toner distribution was moved toward the image bearing member with a somewhat delay time when the magnetic chain caught up with the trailing end of the image. Further, it was observed that a size of the shot trailing end improper development was substantially proportional to the delay time.

### SUMMARY OF THE INVENTION

A principal object of the present invention is to provide an image forming apparatus in which a trailing end improper development is visibly eliminated by defining an operating condition on the basis of an actually measured parameter without adding a magnetic pole to a magnet on the basis of the above-described knowledge.

According to an aspect of the present invention, there is provide an image forming apparatus comprising: an image bearing member; an electrostatic image forming device for forming an electrostatic image on the image bearing member; and a developer carrying member for carrying a developer magnetically attracted on its surface to a developing position where the developer carrying member opposes the image bearing member, wherein the developer carrying member is provided so as to be rotated in a direction opposite to a rotational direction of the image bearing member at a peripheral speed higher than that of the image bearing member, wherein when the peripheral speed of the image bearing member is Vp (m/sec), the peripheral speed of the developer carrying member is Vs (m/sec), and a time, of movement of the developer from the surface of the developer carrying member to the image bearing member, actually measured in a gap between the image bearing member and the developer carrying member is Tsd (sec), the peripheral speeds Vp and Vs and the time Tsd satisfy the following relationship:

(Vs−Vp)×Tsd<3×10⁵ (m).

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is an illustration of a structure of an image forming apparatus.

FIG. 2 is an illustration of a structure of a photosensitive layer of a photosensitive drum.

Parts (a) to (d) of FIG. 3 are illustrations of structures of photosensitive layers of other photosensitive drums.

FIG. 4 is an illustration of an oscillating voltage applied to a developing sleeve.

FIG. 5 is an illustration of a trailing end improper development.

FIG. 6 is an illustration of a toner on the developing sleeve opposing a non-image region of the photosensitive drum.

FIG. 7 is an illustration of the toner having reached a trailing end of an image region.

FIG. 8 is an illustration of a toner locus in a developing process in the image region.

FIG. 9 is an illustration of a range in which the trailing end improper development is not generated.

FIG. 10 is an illustration of a practical range in which the trailing end improper development is not generated.

FIG. 11 is an illustration of a surface potential of the photosensitive drum before and after development.

FIG. 12 is an illustration of a developing property.

FIG. 13 is an illustration of a developing bias.

FIG. 14 is an illustration of loci of toner particles obtained by model calculation.

FIGS. 15 and 16 are illustrations of experimental results under contacts in Embodiment 1 and Comparison Example 1, respectively.

FIGS. 17 and 18 are illustrations of experimental results under contacts in Embodiment 2 and Comparison Example 2, respectively.

FIGS. 19 and 20 are illustrations of experimental results under contacts in Embodiment 3 and Comparison Example 3, respectively.

### DESCRIPTION OF THE PREFERRED EMBODIMENTS

Embodiments of the present invention will be described specifically with reference to the drawings. The present invention can also be carried out in other embodiments in which a part or all of constitutions of the following embodiments are replaced with alternative constitutions so long as a member for regulating a layer thickness of a developer also functions as a member for rectify a flow of the developer in its upstream side and thus is unified into a single part.

Therefore, the present invention can also be carried out by an image forming apparatus including a developing device using not only a two-component developer but also a one-component developer. In the following embodiments, only a major part of the image forming apparatus relating to formation and transfer of the toner image will be described but the present invention can be carried out in various fields of apparatuses or machines such as printers, various printing machines, copying machines, facsimile machines, and multi-function machines.

### <Image Forming Apparatus>

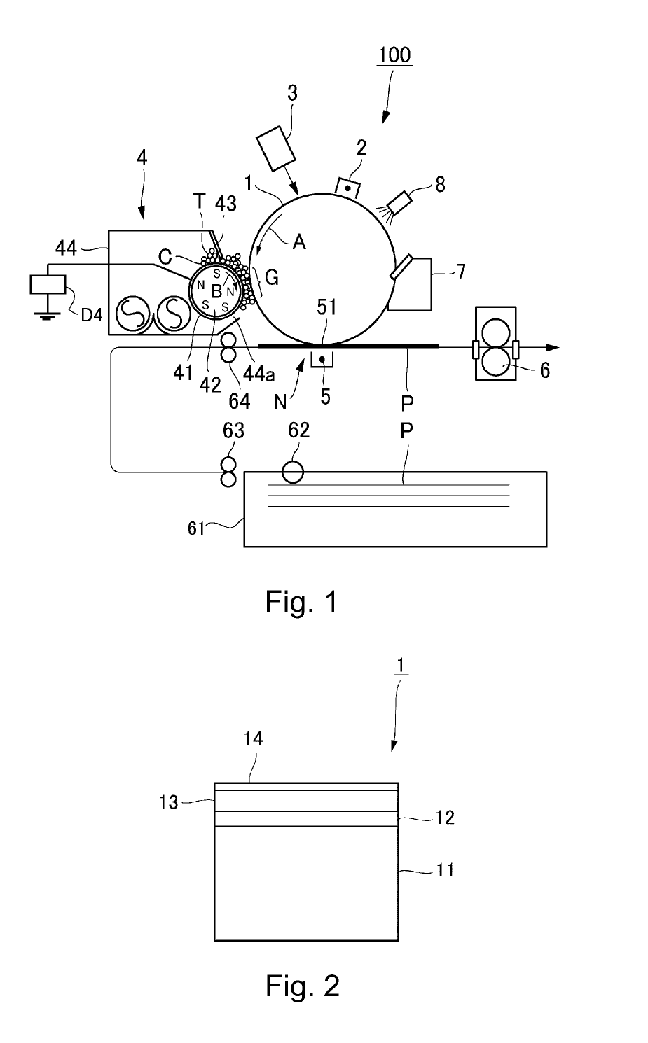

FIG. 1 is an illustration of a structure of an image forming apparatus 100. As shown in FIG. 1, the image forming apparatus 100 is a monochromatic printer in which a toner image is transferred and fixed on a recording material conveyed one by one.

The image forming apparatus 100 includes a photosensitive drum 1, around which a corona charter 2, an exposure device 3, a developing device 4, a transfer charger 5 and a drum cleaning device 7 are provided. The photosensitive drum 1 has a photosensitive layer at its outer peripheral surface, and is rotated in an arrow A direction at a predetermined process speed.

The corona charger 2 emits negatively charged particles with corona discharge, thus electrically charging the photosensitive drum 1 to a uniform negative dark portion potential VD. The exposure device 3 scans the photosensitive drum surface, through a rotating mirror, with a laser beam obtained by ON-OFF modulation of a scanning line image signal developed from a monochromatic image and thus the surface potential of the charged photosensitive drum 1 is lowered to a light portion potential VL, so that an electrostatic image for an image is written (formed) on the photosensitive drum 1. The developing device 4 transfers a toner onto the photosensitive drum 1 to develop the electrostatic image into a toner image.

A separation roller 62 separates sheets of the recording material P, one by one, pulled out from a recording material cassette 61, and sends the recording material P to a registration roller pair 64. The registration roller pair 64 sends the recording material P to a transfer portion 51 while timing the recording material P to the toner image on the photosensitive drum 1. The recording material P on which the toner image is transferred is subjected to application of heat and pressure by a fixing device 6, so that the toner image is fixed on the surface of the recording material P. The drum cleaning device 7 rubs the photosensitive drum 1 with a cleaning blade to remove a transfer residual toner deposited on the photosensitive drum 1 without being transferred onto the recording material P. A pre-exposure device 8 irradiates the surface of the photosensitive drum 1 with light to electrically initialize the photosensitive drum surface, thus enabling repetition of the above-described image forming operation.

### <Photosensitive Drum>

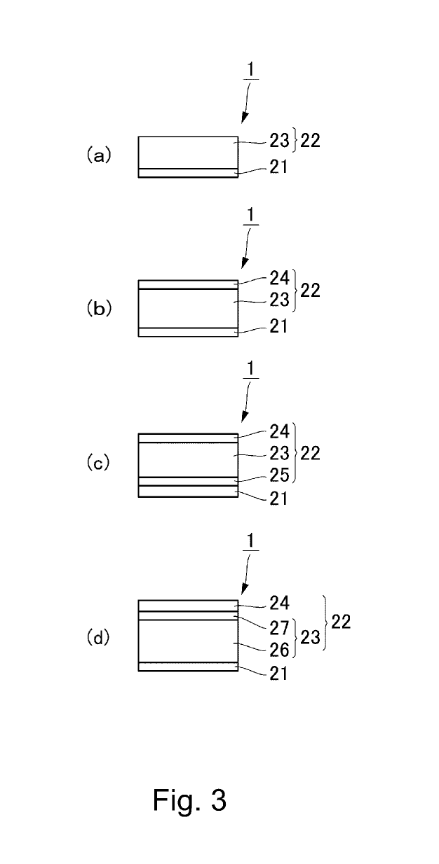

FIG. 2 is an illustration of a structure of the photosensitive layer of the photosensitive drum 1. Parts (a) to (d) of FIG. 3 are illustrations of photosensitive layer structures of other photosensitive drums 1.

As shown in FIG. 2, as the photosensitive drum 1, an ordinary OPC type photosensitive member which is a photosensitive member including at least an organic photoconductor layer is used. The OPC type photosensitive member is prepared by forming, on an electroconductive support, a photosensitive layer (photosensitive film) including a photoconductive layer formed of an organic photoconductor as a main component. On a metal support 11, layers consisting of a charge generating layer 12, a charge transporting layer 13 and a surface protective layer which are formed of organic materials are laminated.

As shown in FIG. 3, as the photosensitive drum 1, it is also possible to use an a-Si photosensitive member, which is a photosensitive member including at least an amorphous silicon layer. The a-Si photosensitive member includes the electroconductive support and a photosensitive layer (photosensitive film), provided on the support, including a photoconductive layer principally formed of an amorphous silicon. The a-Si photosensitive member generally has the following layer structures.

(1) As shown in (a) of FIG. 3, on a supporting member (support) 21 for the photosensitive member, a photosensitive film 22 is provided. The photosensitive layer 22 is, in this example, constituted by a photoconductive layer 23 which is formed of a-Si:H,X (H: hydrogen atom, X: halogen atom) and which has electroconductivity.

(2) As shown in (b) of FIG. 3, with respect to the a-Si photosensitive member, on a supporting member 21 for the photosensitive member, a photosensitive film 22 is provided. The photosensitive layer 22 is constituted by a photoconductive layer 23 which is formed of a-Si:H,X and which has electroconductivity, and by an amorphous silicon-based surface layer 24.

(3) As shown in (c) of FIG. 3, with respect to the a-Si photosensitive member, on a supporting member 21 for the photosensitive member, a photosensitive film 22 is provided. The photosensitive layer 22 is constituted by a photoconductive layer 23 which is formed of a-Si:H,X and which has electroconductivity, an amorphous silicon-based surface layer 24, and an amorphous silicon-based charge injection blocking layer 25.

(4) As shown in (d) of FIG. 3, with respect to the a-Si photosensitive member, on a supporting member 21 for the photosensitive member, a photosensitive film 22 is provided. The photosensitive layer 22 is constituted by a photoconductive layer 23 which is constituted by a charge generating layer 26 formed of a-Si:H,X and a charge transporting layer 27, and is constituted by an amorphous silicon-based surface layer 24.

Incidentally, the layer structure of the photosensitive drum 1 is not limited to those as shown in FIGS. 2 and 3 but the photosensitive drum 1 may also have other layer structures.

### <Developing Device>

In recent years, with advance of digitalization, full-colorization and speed-up of the image forming apparatus of the electrophotographic type, an output image has a value as an original output product and thus the image forming apparatus is expected to move into a printing market. The image forming apparatus is required to output an image with high and stable image quality (high definition). In order to obtain a high-definition image quality, the image forming apparatus is required that a developing property is improved and a degree of image defect is reduced.

As shown in FIG. 1, the developing device 4 carries on a developing sleeve 41 a two-component developer obtained by mixing a toner T as non-magnetic toner particles with a carrier C as magnetic carrier particles in a weight ratio of about 10%, and supplies the developer to the photosensitive drum 1, thus developing the electrostatic image into the toner image. The toner image is substantially formed only of the toner of the two-component developer.

The toner and the carrier in the present invention are not limited but specifically those of various types described later may be used. The toner may preferably contain a wax as a parting agent and a charge control agent such as an organic metal complex.

A desired toner charge amount Q/M is ensured by adjusting the weight ratio of the toner to the carrier and the type and amount of an external additive to be added to the toner.

A developing container (developing device body) 44 accommodates the two-component developer. The developing sleeve 41 is rotatably provided at an opening of the developing container 44 and incorporates therein a magnet 42 as a magnetic field generating means. The developing sleeve 41 is rotated so that its surface moves in a B direction, which is the same direction as that of the photosensitive drum 1, at a developing portion G where the developing sleeve 41 opposes the photosensitive drum 1. The developing sleeve 41 is rotationally driven so that its surface moves at a speed Vs higher than that of the photosensitive drum 1.

The two-component developer is carried on the surface of the developing sleeve 41 in the developing container 44 and then a layer thickness of the developer is uniformly controlled by a layer thickness regulating member 43, and thereafter the developer is conveyed to the developing portion G where the developing sleeve 41 opposes the photosensitive drum 1. A positively charged carrier C is constrained by the surface of the developing sleeve 41 and adsorbs a negatively charged toner T to convey the toner T to the developing portion G. The toner T is stirred and mixed with the carrier C to be triboelectrically charged to the desired toner charge amount Q/M.

The two-component developer on the developing sleeve 41 is erected at the developing portion G by the magnetic field generated by the magnet 42 to form a magnetic brush, so that the surface of the photosensitive drum 1 is rubbed with an end of the magnetic brush. An oscillating voltage in the form of a DC voltage Vdc biased with an AC voltage Vac is applied to the peripheral speed 41, so that only the toner T is transferred from the developing sleeve 41 onto the photosensitive drum 1.

In the image forming apparatus 100, the photosensitive drum 1 is negatively charged, and the electrostatic image is formed by an image exposure system in which the electrostatic image is formed by effecting exposure at an image portion. The toner is charged to the negative polarity identical to a charge polarity of the photosensitive drum 1 by triboelectric charge with the carrier. By using the charged toner, the electrostatic image is developed into the toner image by a reverse development system in which the electrostatic image is developed at the image portion exposed to light on the photosensitive drum 1.

### <Oscillating Bias>

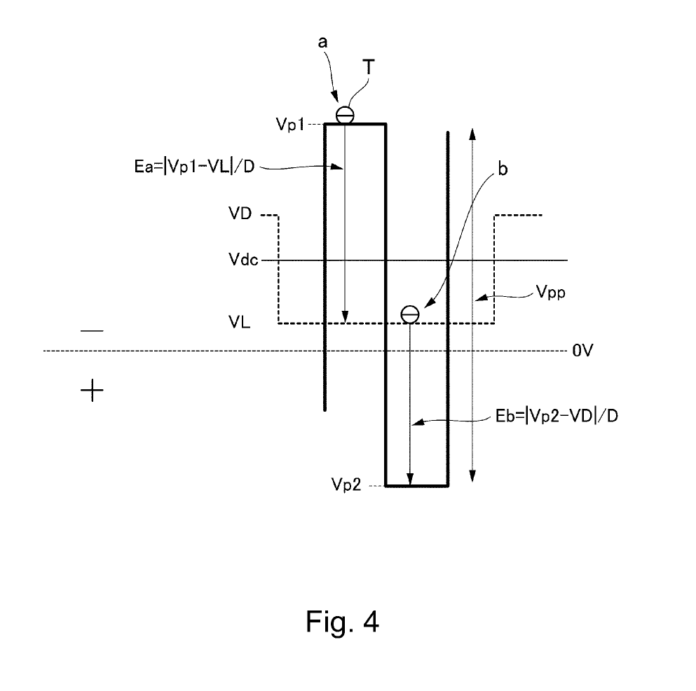

FIG. 4 is an illustration of the oscillating voltage applied to the developing sleeve. In FIG. 4, an abscissa represents a time, and an ordinate represents a potential. As shown in FIG. 4, to the developing sleeve 41, a developing bias of an ordinary rectangular wave is applied. The developing bias is the oscillating voltage in the form of the DC voltage Vdc, determined as an intermediate value between the above-described light portion potential VL and dark portion potential VD, biased with the AC voltage Vac having a peak-to-peak voltage Vpp which has peak potentials Vp1 and Vp2. The developing bias is applied between the photosensitive drum 1 and the developing sleeve 41.

In FIG. 4, the dark portion potential VD is the negative potential of the photosensitive drum 1 charged by the corona charger 2. The light portion potential VL is the potential of the first portion where the dark portion potential VD is lowered by subjecting the photosensitive drum 1 to exposure to light by the exposure device 3. The light portion potential VL is the potential at which a toner deposition amount becomes largest to obtain a maximum density of the fixed image.

As shown in FIG. 4, when the potential Vp1 of the peak potentials of the developing bias of the rectangular wave is applied to the developing sleeve 41, a largest developing contrast (potential difference) with respect to the light portion potential VL is formed. A developing electric field by the potential difference moves the toner from the developing sleeve 41 to the photosensitive drum 1.

On the other hand, when the potential Vp2 of the peak potentials of the developing bias of the rectangular wave is applied to the developing sleeve 41, the potential difference in a direction opposite from that when the developing electric field is formed is formed with respect to the light portion potential VL. A pull-back electric field by the potential difference in the opposite direction pulls back the toner deposited in a region of the light portion potential VL of the photosensitive drum 1 to be moved toward the developing sleeve 41.

A field intensity Ea of the developing electric field and a field intensity Eb of the pull-back electric field are represented by the following formulas (1) and (2), respectively.

Ea=|(Vp1−VL)|/D (1)

Eb=|(Vp2−VL)|/D (2)

VL: electrostatic image potential (V) for obtaining maximum density

Vp1: peak potential (V) of oscillating voltage for moving toner to photosensitive drum portion with light portion potential VL

Vp2: peak potential (V) of oscillating voltage for moving toner from photosensitive drum portion with light portion potential VL to developing sleeve 41

Vdc: PC component (V) of oscillating voltage

D: closest distance (m) between photosensitive drum 1 and developing sleeve 41

The field intensity Ea of the developing electric field is referred to as a developing field intensity. The field intensity Eb of the pull-back electric field is referred to as a pull-back field intensity. When the peak-to-peak voltage (V) of the AC voltage Vac is Vpp, the peak potentials Vp1 and Vp2 are represented by the following formulas (3) and (4) depending on the charge polarity of the toner.

(When toner has negative (−) polarity)

Vp1=Vdc−|Vpp/2|, Vp2=Vdc+|Vpp/2| (3)

(When toner has positive (+) polarity)

Vp1=Vdc+|Vpp/2|, Vp2=Vdc−|Vpp/2| (4)

In such an image forming apparatus, in the case where a rotational speed of the developing sleeve 41 is set at a high value and then the image is formed, the trailing end improper development can occur by the following mechanism.

### <Experimental Machine for High-Speed Shooting>

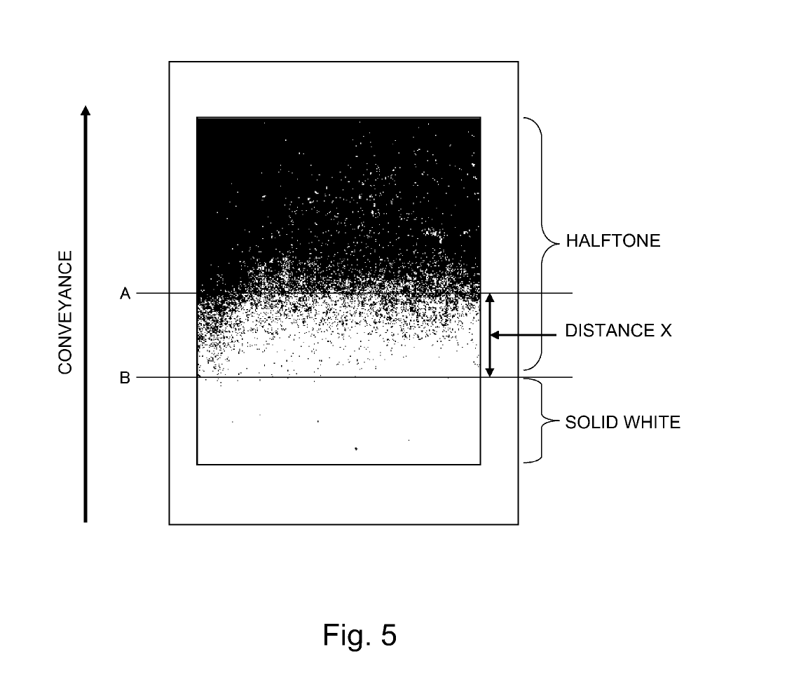

FIG. 5 is an illustration of the trailing end improper development. As shown in FIG. 1, in the image forming apparatus 100, the two-component developer carried on the developing sleeve 41 provided to the developing device 4 is conveyed to the developing portion G where the developer opposes the electrostatic image on the photosensitive drum 1. Then, in a state in which the magnetic chain of the two-component developer on the developing sleeve is caused to contact or come near to the photosensitive drum 1, only the toner is moved onto the photosensitive drum 1 by the developing bias applied between the developing sleeve 41 and the photosensitive drum 1, so that the toner image depending on the electrostatic image is formed.

In the two-component development type (system), for the purposes of improving the developing property and of reducing the degree of image defect, various contrivances are made. One of the contrivances is provision of a peripheral speed difference between the developing sleeve and the photosensitive drum. In general, by providing the developing sleeve with a peripheral speed higher than that of the photosensitive drum, a good image is obtained. This is because a supply amount of the toner conveyed by the carrier carried on the developing sleeve is increased. When the developing sleeve is moved at a higher speed than that of the photosensitive drum, an opportunity to transfer a new toner in a large amount onto the electrostatic image on the photosensitive drum is increased.

However, when the developing sleeve is provided with the higher peripheral speed than that of the photosensitive drum, also the image defect is generated. One of the types of the image defect is image defect caused by a lowering in image density at a trailing end (portion) of the image. This is conspicuous particularly in the case of an image with intermediary gradation level (halftone image) of a digital type. It would be considered that the image defect is generated by the following three reasons.

(1) A first reason is that the toner once used for developing the electrostatic image is removed by a counter charge of the carrier.

(2) A second reason is that the presence of the peripheral speed difference between the developing sleeve and the photosensitive drum. In a conventional image forming apparatus, a process speed is not higher than that of a current image forming apparatus and therefore there was no problem of the trailing end improper development due to the peripheral speed difference. However, it would be considered that the problem becomes apparent by an increase in peripheral speed difference with an increasing process speed in recent years.

(3) A third reason is that the toner is deteriorated to lower the toner charge amount Q/M and therefore it would be considered that followability of the toner to the developing electric field is lowered and thus the image density at the trailing end portion cannot be ensured.

Therefore, in order to clarify the mechanism of the trailing end improper development, observation of behavior of the toner at the developing portion was tried. However, it is difficult to observe the toner behavior in the opposite region (developing portion) between the photosensitive drum and the developing sleeve during an operation of the image forming apparatus for the following two reasons.

(1) A first reason is that there is no space in which an observation device is provided in the image forming apparatus (copying machine).

(2) A second reason is that there is no space in which an illumination device is provided. In order to clearly shoot the toner of a several μm level travelling at a high speed, a sufficient light source is needed. However, a toner travelling space (developing portion formed in a gap between the developing sleeve and the photosensitive drum) is merely about several tens of μm and therefore is insufficient to dispose the illumination device therein.

Therefore, the present inventors prepares, not an actual copying machine, an experimental machine for high-speed shooting which simulates the actual copying machine, and shoots the toner behavior by using the experimental machine to observe the toner behavior in slow motion, thus specifying the mechanism of the trailing end improper development. The experimental machine is specifically constituted by a high-speed camera, a developing device for the experimental machine, and a charging drum of aluminum. As the high-speed camera, a high-speed camera (“APX-RS”, mfd. by Photron Ltd.) was used.

The developing device for the experimental machine was prepared in the same cross-sectional constitution and dimension as those of the image forming apparatus 100, and a diameter was 84 mm for the charging drum (corresponding to the photosensitive drum 1) and was 24.5 mm for the developing sleeve. In view of shooting, a length of each of the charging drum and the developing sleeve with respect to a rotational axis direction was 16 mm. As the charging drum, a cylindrical member of aluminum the surface of which is coated with an about 30 μm-thick film of indium-tin oxide was used.

For charging the charging drum (corresponding to formation of the electrostatic image), a rubber roller was used. A material of a rubber used for the rubber roller may only be required to maintain electroconductivity and is not limited. First and Second (two) rubber rollers were used and provided upstream of the developing device for the experimental machine with respect to the rotational direction of the charging drum.

The first number roller was disposed upstream of the second rubber and to which the function of charging the charging drum uniformly to the dark portion potential VD was imparted. To the second rubber roller, an oscillating voltage was applied so that a 10 mm-portion of the light portion potential VL was intermittently formed, as the electrostatic image, at an interval of 10 mm with respect to the rotational direction in a region where the charging drum was uniformly charged to the dark-portion potential VD. A high-voltage source unit was connected to the first and second rubber rollers, and a voltage applied from the high-voltage source unit is adjusted so that each of the dark portion potential VD and the light portion potential VL to which the charging roller was charged was a desired potential.

As shown in FIG. 5, when the experimental machine for high-speed shooting was operation under the same condition as that of the actual machine of the image forming apparatus to observe the toner behavior, similarly as in the case of the actual machine, the trailing end improper development was observed on the charging drum.

The operating condition under which the trailing end improper development was generated in both of the actual machine of the image forming apparatus and the experimental machine for high-speed shooting was as follows. That is, the operating condition includes the dark portion potential VD=−500 V, the light portion potential VL=−300 V, the developing bias DC voltage Vdc=−350 V, the developing sleeve peripheral speed Vs=500 mm/sec, and the photosensitive drum (charging drum) peripheral speed Vp=300 mm/sec.

That is, a trailing end improper development phenomenon itself can be regarded as being the same between the actual machine of the image forming apparatus and the experimental machine for high-speed shooting. Further, by analyzing the toner behavior by using motion picture images shot by the experimental machine for high-speed shooting, a cause of the image defect generated in the actual machine of the image forming apparatus could be formed. When the motion picture images shot by the experimental machine for high-speed shooting were analyzed, it was turned out that the trailing end improper development phenomenon is a phenomenon generated because movement of the toner attracted toward the developing sleeve is not in time when the developing sleeve has the higher peripheral speed than that of the photosensitive drum.

Incidentally, in the experimental machine for high-speed shooting a length of the trailing end improper development generated on the charging drum tended to be longer than that observed by print output by the actual machine. This may be because the toner image formed on the photosensitive drum by development is subjected to a fixing process in which the image is fixed on the recording material, after being subjected to a transfer process in which the toner image is transferred onto the recording material. That is, in the transfer process, the location of the toner image on the photosensitive drum cannot be accurately reproduced on the paper (recording material), so that an amount of the toner scattered onto the non-image portion is not so small. For that reason, there is a possibility that the toner is transferred onto also the portion where the trailing end improper development is originally generated, and in that case, a distance of the trailing end improper development is shortened. Further, also in the fixing process, heating and pressing are carried out for fixing the toner on the paper in general and therefore as a result, the toner is melted and spread out, so that the distance of the trailing end improper development is alleviated correspondingly.

Therefore, it would be considered that a difference in length of the trailing end improper development distance is generated between the actual machine and the visualization apparatus (experimental machine for high-speed shooting) by the influence of the transfer process and the fixing process which are performed by the actual copying machine but are not performed by the experimental machine for high-speed shooting, and thus the length of the trailing end improper development is shorter in the actual machine than in the experimental machine.

### <Mechanism of Trailing End Improper Development>

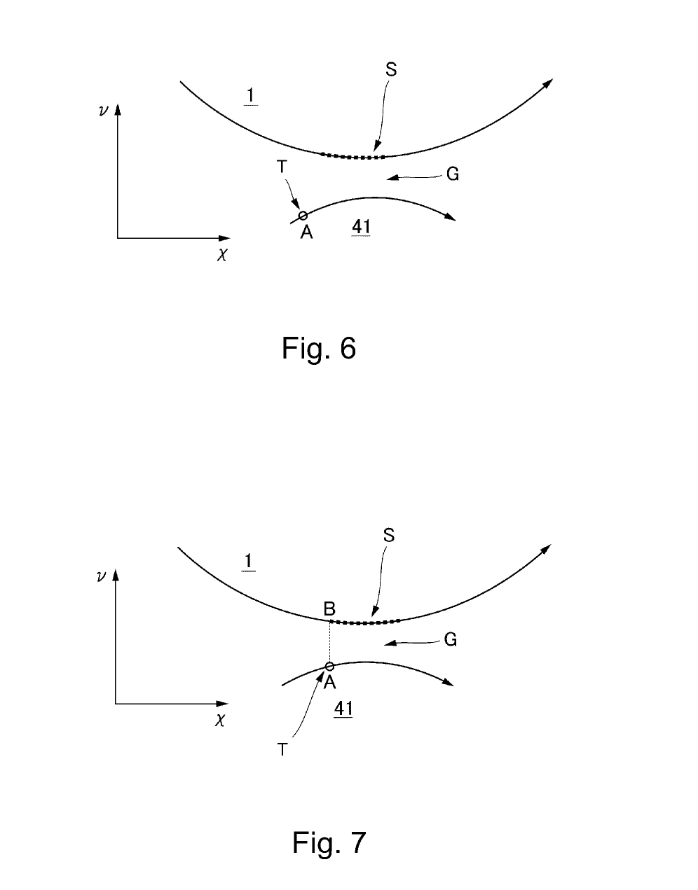

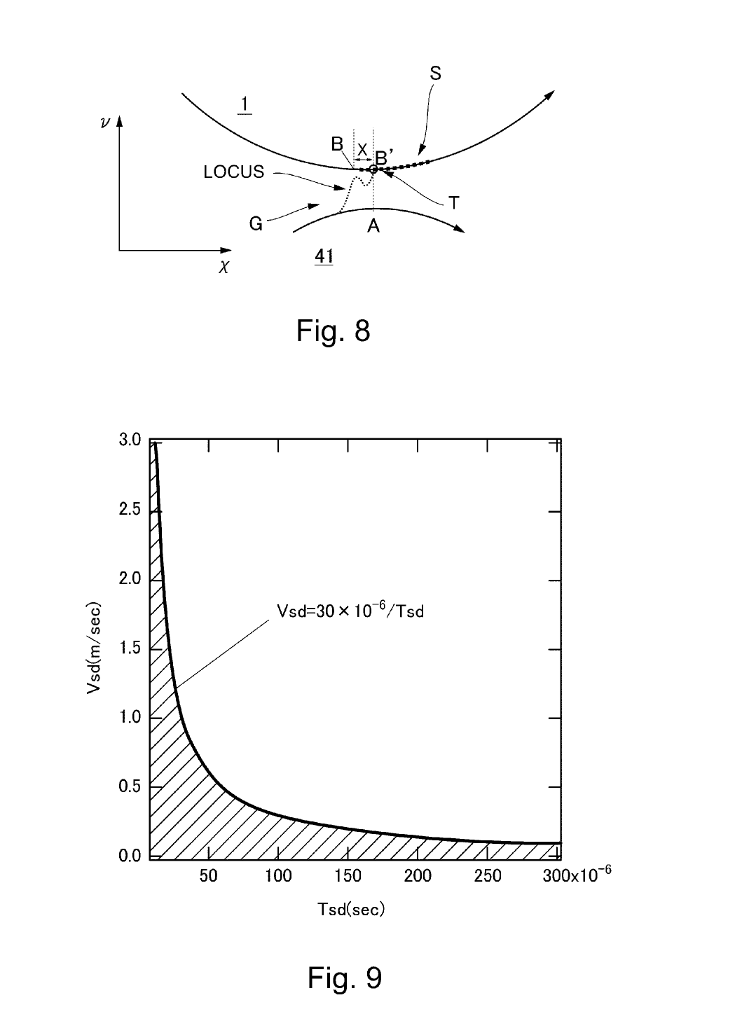

FIG. 6 is an illustration of a toner on the developing sleeve opposing a non-image region of the photosensitive drum. FIG. 7 is an illustration of the toner having reached a trailing end of an image region. FIG. 8 is an illustration of a toner locus in a developing process in the image region.

FIGS. 6, 7 and 8 are schematic views drawn by paying attention to a sing particle of the toner T during the developing process. For brief explanation, only the single particle of the toner is drawn, so that other toner particles and carrier particles at a periphery of the single toner particle are omitted from illustration.

In a state of FIG. 6, an electrostatic image S is formed on the photosensitive drum 1 and the toner T opposes the non-image region in front of the electrostatic image S. Referring to FIG. 6, it is assumed that the potential of the develop 1 in the non-image region is VD=−500 V and the potential of the developing sleeve 41 is Vdc=−350 V. It is also assumed that the potential of the electrostatic image S is −300 V, the potential in the non-image region is −500 V, the DC voltage of the developing bias applied to the developing sleeve 41 is −350 V, and the toner is charged to the negative polarity.

According to the observation of the image in slow motion, at a certain instant, the toner T is positioned upstream of the electrostatic image in the developing region G and opposes the non-image region. In a state in which the toner T opposes the non-image region, the negatively charged toner T is attracted to the developing sleeve 41. The toner T opposes the non-image region and based on a potential relationship, is attracted to the developing sleeve 41.

Further, the magnetic chain formed by the carrier and carried on the developing sleeve 41 is rotated at the speed equal to that of the developing sleeve 41 and therefore also the toner T carried on the magnetic chain (or the toner T floating between closely formed magnetic chains) is moved at the speed equal to that of the developing sleeve 41. The speed of the toner T in an x direction is Vs. The developing sleeve 41 is rotated at the speed higher than that of the photosensitive drum 1 and therefore the toner T surrounded by the magnetic chain of the developer is moved in the x direction at the speed equal to that of the developing sleeve 41.

However, in order to further improve the developing property of the electrostatic image S, the peripheral speed Vs of the developing sleeve 41 is set at a value larger than that of the peripheral speed of the photosensitive drum 1. For that reason, the toner opposing the non-image region of the photosensitive drum 1 catches up with the trailing end of the electrostatic image S in a state in which the toner is still attracted to the developing sleeve 41, and then starts to move toward the photosensitive drum 1 in response to the potential difference between the photosensitive drum 1 and the developing sleeve 41. When attention is paid to whether the toner moved from the state of FIG. 6 in the x direction is deposited on what place of the electrostatic image S to develop the electrostatic image S, the trailing end improper development phenomenon stands out in relief.

As shown in FIG. 6, the toner opposing the non-image region is attracted to the developing sleeve 41 based on the potential relationship. Further, when there is no peripheral speed difference between the developing sleeve 41 and the photosensitive drum 1, the trailing end improper development is not generated. However, unless the amount of the toner sent to the developing portion G is increased by providing the peripheral speed difference at a certain level or more, at a high process speed, the toner supply is insufficient and thus the developing property is remarkably lowered. For this reason, the developing sleeve 41 is rotated at the peripheral speed higher than that of the photosensitive drum 1, so that the toner T is moved to a position where the toner T opposes the image region.

As shown in FIG. 7, thereafter the toner T starts development from the time when it catches up with the electrostatic image S by the peripheral speed difference between the developing sleeve 41 and the photosensitive drum 1. However, there is a distance between the developing sleeve 41 and the photosensitive drum 1 and therefore the toner T cannot reach the trailing end of the image region which first opposes the toner T, so that the electrostatic image is developed with the toner at a place spaced from the image region trailing end by a certain distance X. During repetition of this process, the toner image with the trailing end improper development is visualized macroscopically. With respect to a halftone image, visual sensitivity to a difference in toner amount per unit area becomes high and therefore a density difference in trailing end improper development becomes conspicuous especially.

As shown in FIG. 8, the toner originally placed in the state in which it is attracted to the developing sleeve 41 reaches the photosensitive drum 1 along its locus, thus developing the electrostatic image into the toner image. The locus can be mathematically analyzed as described later. However, in order to solve the trailing end improper development, the present inventors analyzed the shot image to study shortening of a time Tsd required until the toner reaches the photosensitive drum 1. In the following, a generating mechanism of the trailing end improper development and a measuring method of the time will be described.

In accordance with the above-described theory, when there is the peripheral speed difference between the developing sleeve 41 and the photosensitive drum 1, in order to reduce the trailing end improper development, there is a need to cause the toner, attracted to the developing sleeve 41 by being repelled by the dark portion potential VD in the non-image region, to reach the develop 1 early. It would be considered that a distance x in which the trailing end improper development is generated is determined by the time Tsd required until the toner reaches the photosensitive drum 1, and therefore there is a need to control the time Tsd so that the distance x falls within an allowable range.

The present inventors analyzed the shot motion picture images of the experimental machine for high-speed shooting by a manual operation, so that the time Tsd required until an individual toner particle reached from the developing sleeve to the charging drum was measured. Specifically, many still picture images constituting the motion picture images was edited by using an editing software for a photographic image (“Adobe Photoshop CS2” (registered trademark), available from Adobe Systems Inc.). A contour of the toner particle was emphasized by subjecting the still picture images to unsharp mask so as to be converted into gray-scale images.

Thereafter, the individual toner particle was tracked by eye observation by using an image analyzing software (“Image-Pro Plus” (registered trademark), available from Adobe Systems Inc.) to specify a movement position of each still picture image for motion picture image. The times required until 100 toner particles reached the charging drum was individually measured, and were averaged to obtain the time Tsd required until each toner particle reached the charging drum.

The motion picture image shot by the experimental machine for high-speed shooting is an aggregate of the still picture images and is discontinuous in terms of time, and therefore the toner particle may only be required to be accidentally shot as an image at an instant when it reaches the charging drum but is ordinarily shot as two continuous images consisting of an image thereof before reaching and an image thereof bounced after reaching. In such a case, the time required until the toner particle reaches the charging drum cannot be accurately specified but when a shooting frame rate of the high-speed camera is increased to a certain level, the time may be substituted with an intermediate value for the images before and after the toner particle reaches the charging drum. Specifically, when the high-speed camera frame rate is 500,000 frames/sec or more, it would be considered that an error is less even when the time is substituted with the intermediate value.

The reason therefor is that in the case where the toner particle is shot at the frame rate of 500,000 frames/sec or more, a time interval between the two still picture images is 1/500,000 sec or less, i.e., 2 μsec or less although it depends on a shutter speed. Therefore, the error, of the time required until the toner particle reaches the charging drum, generated by using the intermediate value of the images before and after the toner particle is suppressed to 2 μsec or less, so that sufficient accuracy can be ensured with respect to the time Tsd at a level of 100-300 μsec.

### <Parameter of Trailing End Improper Development>

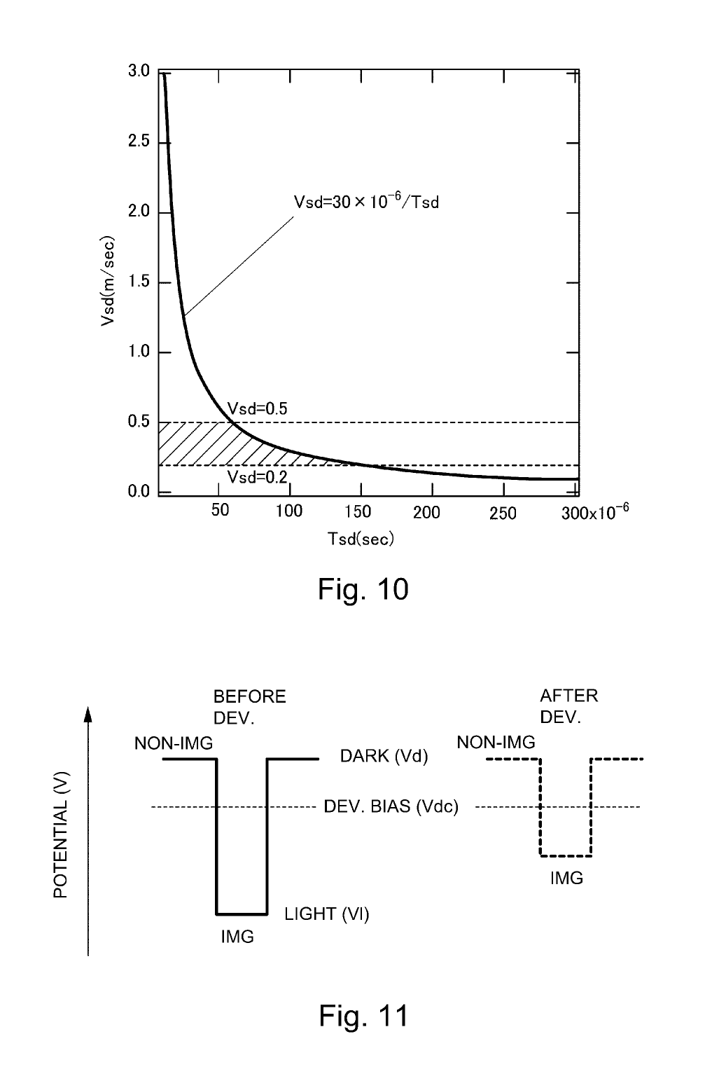

FIG. 9 is an illustration of a range in which the trailing end improper development is not generated. FIG. 10 is an illustration of a practical range in which the trailing end improper development is not generated.

As shown in FIG. 8, at the developing region G, the magnetic chain formed of the carrier is closely present actually. The rotational direction of the developing sleeve 41 is the x direction. The toner removed from the carrier becomes in motion between the closely present magnetic chains and therefore the toner is rotated in the same direction as that of the developing sleeve 41 at the speed equal to that of the magnetic chain. The magnetic chain is carried on the developing sleeve 41, and the toner is rotated while being constrained by the magnetic chain and therefore, at the developing portion G, the speed of the toner with respect to the x direction is equal to that of the developing sleeve 41. When the speed of the toner with respect to the x direction is v_{X} and the speed of the surface of the developing sleeve 41 is V_{S}, the following formula (5) is satisfied.

v_{X}=V_{S} (5)

Therefore, a position x(t) of the toner with respect to the x direction at an arbitrary time t is represented by the following formula (6).

x(t)=x₀+V_{S}t (6)

Here, x₀ is a position of the toner with respect to the x direction at a time t=0. In order to ensure the developing property, the developing sleeve 41 has the peripheral speed higher than that of the photosensitive drum 1 and therefore the toner moved in the x direction at the speed equal to that of the developing sleeve 41 necessarily passes the electrostatic image, so that the position of the opposing electrostatic image is changed in real time. The distance X from the trailing end of the image on the photosensitive drum at the toner-opposing position is represented by the following formula (7).

X=(v_{X}−V_{P})×Tsd=Vsd×Tsd (7)

V_{X}: toner movement speed

V_{P}: photosensitive drum peripheral speed

Vsd: peripheral speed difference between peripheral speed and photosensitive drum

Tsd: time required until toner reaches photosensitive drum

As shown in FIG. 8, the toner T starts movement from the developing sleeve 41 and reaches the surface of the photosensitive drum 1 with reciprocation movement in response to a pulse polarity of the AC voltage of the oscillating voltage. During the period, the toner T passes the photosensitive drum 1 by the distance X represented by the formula (7) and therefore the toner T does not develop the electrostatic image on the photosensitive drum at a point B but develops the electrostatic image at a point B′ spaced from the point B by the distance X with respect to the photosensitive drum rotational direction.

Such a process is averagely repeated every passage of the toner through the electrostatic image, so that the trailing end improper development is visualized macroscopically. Therefore, in order to alleviate the distance of the trailing end improper development, as apparent from the formula (7), there is a need to decrease the peripheral speed difference Vsd or to shorten the time Tsd.

In actually, in the case where the trailing end improper development distance X is 30 μm or less, the distance X was determined as a visually allowable range. This is because at present, as the carrier used for electrophotography, particles of about several tens of μm in particle size are used and when even one particle of the carrier is deposited on the image as an output product, the carrier is visualized as the image defect and therefore a minimum of distance X is required to be in a range smaller than the carrier particle size. Further, when the distance X is 30 μm or less, the resultant image is actually allowable as an image. This is also confirmed by study of the present inventors. Thus, from the formula (7), the following formula (8) is obtained.

Vsd<(30×10⁻⁶)/Tsd (8)

A region represented by the formula (8) is shown in FIG. 9 as a hatched line portion.

However, the peripheral speed difference Vsd between the developing sleeve 41 and the photosensitive drum 1 closely relates to also the developing property, the carrier deposition, and an image property such as disturbance of the image. For that reason, the peripheral speed difference Vsd is not required to only satisfy the formula (8) but is required to find out a condition for satisfying the formula (8) while satisfying the developing property and the image property. In order to specify a performed range of an ideal peripheral speed difference Vsd, study was made in Embodiments 1 to 3, so that the range was specified. The specified range (region) in Embodiments 1 to 3 is shown in FIG. 10 as a hatched line portion.

An object of the following embodiments is to provide an image forming apparatus capable of obtaining a high developing property while reducing a degree of the trailing end improper development and also ensuring an opportunity to develop the electrostatic image with the toner.

### Embodiment 1

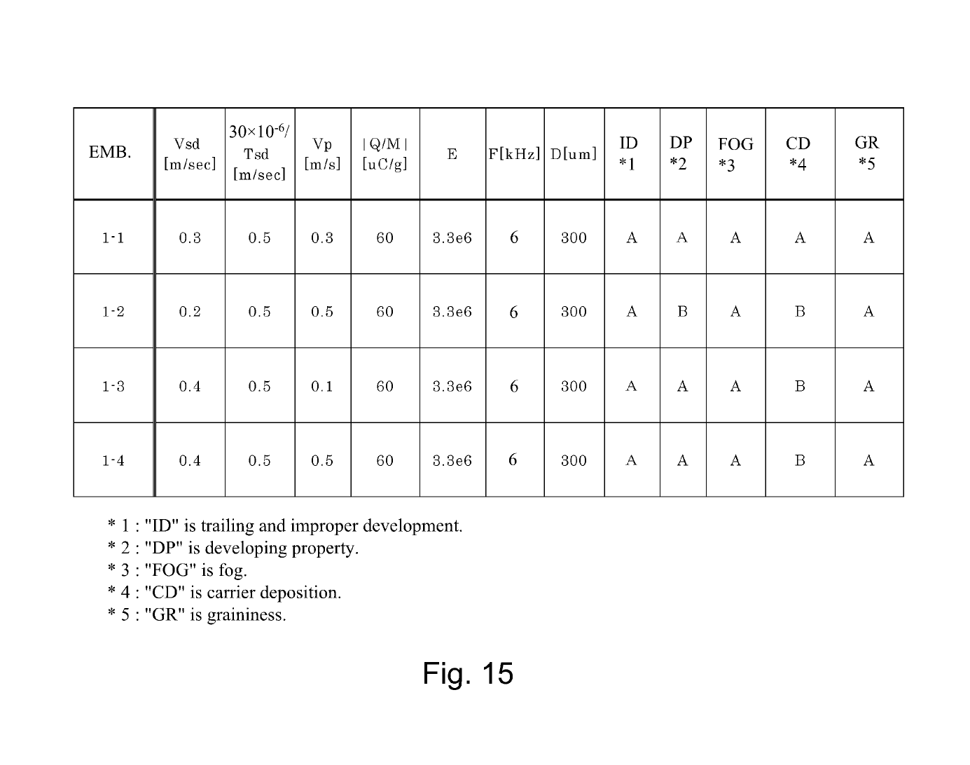

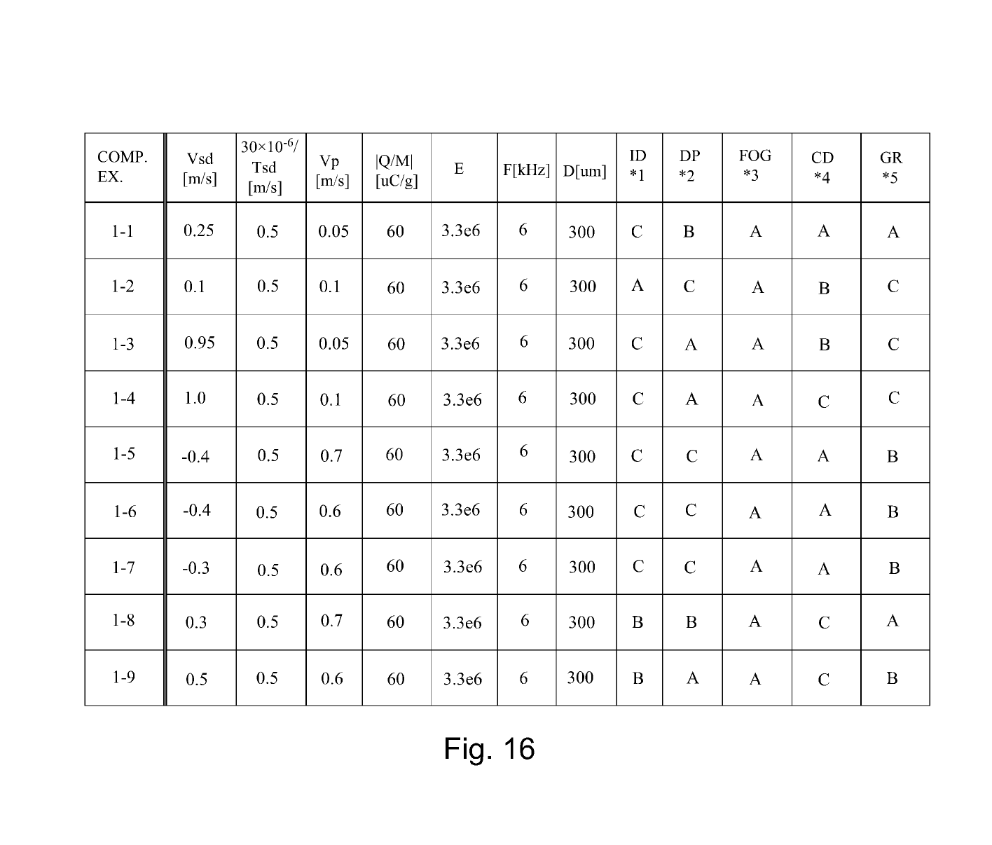

FIG. 15 is an illustration of an experimental result under an operating condition in Embodiment 1. FIG. 16 is an illustration of an experimental result in Comparison Example 1.

As shown in FIG. 1, the exposure device 3 as an example of an electrostatic image forming means forms the electrostatic image on the photosensitive drum 1 as an example of the image bearing member. The developing device 4 as an example of the developer carrying member is provided and spaced from the photosensitive drum 1 with a predetermined gap from the photosensitive drum 1, and magnetically attracts the developer and rotates in the same direction as that of the opposing surface of the photosensitive drum 1 at the peripheral speed higher than that of the photosensitive drum 1. The developing sleeve 41 rubs the photosensitive drum 1 with the magnetic chain of the developer, containing the toner and the carrier, with the predetermined gap to develop the electrostatic image. A voltage source D4 as an example of the voltage source applies the oscillating voltage, in the form of the predetermined DC voltage biased with the predetermined AC voltage, to the developing sleeve 41.

The peripheral speed of the photosensitive drum 1 is Vp, the peripheral speed of the developing sleeve 41 is Vs, and the actually measured time of movement of the developer from the developing sleeve 41 to the photosensitive drum 1 in the predetermined gap is Tsd. In this case, under an operating condition in which the trailing end improper development is not generated, the relationship: (Vs−Vp)×Tsd<3×10⁻⁵ is satisfied. In addition, the peripheral speed Vp of the photosensitive drum 1 is 0.1 m/sec or more and 0.5 m/sec or less, and the relationship: 0.2 (m/sec)<(Vs−Vp)<0.5 (m/sec) is satisfied.

An evaluation method of the image forming apparatus is as follows. At a boundary position of the electrostatic image on the photosensitive drum 1 with respect to the rotational direction, the time of the movement of the toner from the developing sleeve 41 to the photosensitive drum 1 is actually measured. Then, whether or not the measured time is shorter than a predetermined time associated with the trailing end improper development is discriminated. As a result, whether or not a combination of various conditions such as the opposing distance, the relative speed, the field intensity, and the toner charge amount Q/M is problematic in terms of the trailing end improper development can be accurately discriminated. Properness of these many physical parameters can be evaluated by using only a single parameter actually measured.

Tsd is the parameter of the trailing end improper development. The experimental machine for high-speed shooting is a simulation apparatus of the toner behavior in an opposing gap in which an operation state of the photosensitive drum 1 and developing sleeve 41 is reproduced in cross-section perpendicular to the axis by using the charging drum and the developing sleeve. In the parameter measuring method, the opposing distance between the charging drum and the developing sleeve is shot as the motion picture image from the rotational axis direction to track the individual toner particle on the still picture image constituting the motion picture image, thus obtaining the time Tsd of the movement of the toner particle from the developing sleeve 41 to the photosensitive drum 1.

On the charging drum, a potential inversion position corresponding to the dark portion potential and light portion potential of the photosensitive drum 1 is formed. The toner particle tracked in the still picture image is the toner particle moved in the opposing gap from a position opposing a potential region corresponding to the dark portion potential to a potential region corresponding to the light portion potential with rotation of the charging drum.

In Embodiment 1, in the image forming apparatus 100, the trailing end improper development was evaluated by variously changing the peripheral speed Vs of the developing sleeve 41, the peripheral speed Vp of the photosensitive drum 1, values of a frequency f and peak-to-peak voltage Vpp of the applied developing bias, and the toner charge amount per unit weight Q/M. In addition, the developing property and image property (carrier deposition, graininess, fog) of the output image were evaluated. In the case where any one of these properties is out of an allowable range, the result is regarded as being the case where an image evaluation criterion in Embodiment 1 is not satisfied, thus falling in the evaluation result of Comparison Example 1.

First, by using the experimental machine for high-speed shooting, the developing sleeve peripheral speed Vs, the charging drum peripheral speed Vp and the peripheral speed difference between the developing sleeve and the charging drum were changed, and the time Tsd required until the toner reaches the charging drum was actually measured by using the above-described procedure. Then, the image forming apparatus 100 (FIG. 1) was operated under the same condition to measure remaining items, so that a relationship between each value and an associated one of the measuring items described above was measured and then was evaluated in accordance with each evaluation criterion described later.

As shown in FIG. 15, under operating conditions of Embodiments 1-1 to 1-4, all of the evaluation criteria were satisfied. In Embodiments 1-1 to 1-4 in which the peripheral speed difference Vsd is 0.2-0.5 (m/sec) and the photosensitive drum peripheral speed Vp is 0.1-0.5 (m/sec), the trailing end improper development distance, the developing property and the image property satisfy the evaluation criteria described later and thus are compatibly realized.

As shown in FIG. 16, under operating conditions of Comparison Examples 1-1 to 1-9, one or more evaluation criteria could not be satisfied. In Comparison Examples 1-3 and 1-4 in which the relationship of the formula (8) is not satisfied, the trailing end improper development was conspicuous. Even when the parameters such as the toner charge amount and the field intensity are similar to those in Embodiment 1 (Embodiments 1-1 to 1-4), unless the peripheral speed difference Tsd between the developing sleeve and the drum satisfy 0.2-0.5, all of the above-described evaluation criteria such as the trailing end improper development distance, the developing property and the image property are not completely satisfied.

Further, in Comparison Examples 1-1 to 1-3 and 1-5 to 1-7 in which the peripheral speed difference Vsd is less than 0.2 (m/sec), a necessary developing property cannot be obtained. When the peripheral speed difference of 0.2 (m/sec) or more is not provided, the amount of the toner supplied to the image region is insufficient and thus a necessary developing property is not obtained, and therefore a lower limit of the peripheral speed difference Vsd is provided. The trailing end improper development distance X is, as described above, disadvantageous with an increasing peripheral speed difference Vsd and therefore as an upper limit of the peripheral speed difference Vsd, a limitation of 0.5 (m/sec) is imposed.

Further, with respect to limitation to the peripheral speed Vp of the photosensitive drum 1, when a range in which a proper peripheral speed difference Vsd is obtained on the basis of the peripheral speed Vs of the developing sleeve 41 is taken into consideration, there is a need that Vp is 0.1 (m/sec) or more and 0.5 (m/sec) or less. The upper limit of the peripheral speed Vp is provided because when the peripheral speed Vs of the developing sleeve 41 is 1.0 (m/sec) or more, a centrifugal force exerted on the carrier exceeds a magnetic retaining force of the developing sleeve 41 and thus the carrier is deposited on the photosensitive drum 1. Further, it is also because when the magnetic chain rubs the toner image at high speed, the toner image is disturbed and thus a resolution of the image is lowered. The lower limit of the peripheral speed Vp is provided because when the speed at a certain level or more is not originally provided to the photosensitive drum 1, productivity cannot be obtained. Further, when the peripheral speed Vp of the photosensitive drum 1 is excessively small, there is also a problem that a degree of fog is worsened.

Based on the above-described reasons and from the results of FIGS. 15 and 16, the condition in which the developing property and the image property were compatibly satisfied while satisfying the formula (8) was determined. The various measuring items in FIGS. 15 and 16 were measured and evaluated in the following manners.

### <Trailing End Improper Development Distance>

First, a definition and measuring method of the trailing end improper development distance X will be described. The trailing end improper development distance X is defined as a length, of paper with respect to a paper (recording material) conveyance direction, in a region where a value of an average density of those measured at random at 5 points with respect to a direction perpendicular to the paper conveyance direction, i.e., a so-called longitudinal direction, is DT=0.3 or less.

As shown in FIG. 5, a region between lines A and B is the region where the density is 0.3 or less, and in the region, a distance of the recording material with respect to the recording material conveyance direction is the trailing end improper development distance X. Further, the density referred to herein is a transmission density DT measured by using a transmission densitometer (“TD-904”, mfd. by Gretag Macbeth). The reason why the transmission density DT is used is that a relationship between the toner amount per unit volume and the image density is described in a state the influence of glossiness resulting from a surface state of the toner layer on the recording material is eliminated.

The recording material used was “OK Top Coat” (basis weight: 73.3 g/m²) manufactured by Oji Holdings Corp. In the following description, all the recording materials are this coated paper.

Evaluation A: 0≦X≦15 μm . . . Good

Evaluation B: 15 μm≦X≦30 μm . . . Allowable

Evaluation C: 30μ<X . . . Poor (No-good)

In the present invention, when the peripheral speed difference Vsd between the developer carrying member and the image bearing member and the time Tsd required until the toner reaches the image bearing member are decreased, the trailing end improper development distance can be shortened. In order to shorten the trailing end improper development distance X to alleviate a degree of the image defect, the time Tsd required until the toner reaches the charging drum may only be required to be shortened. According to study by the present inventors, when the trailing end improper development is 20 μm or less, the distance may be discriminated that it falls under a visually allowable range.

In the case where the trailing end improper development distance X is 30 μm or less, the distance was discriminated that it fallen under the visually allowable range. By setting the time Tsd, required until the toner reaches the image bearing member, in the proper range, it is possible to compatibly realize suppression of the trailing end improper development distance X to 30 μm or less and the developing and image properties. The lowering in image density of the half-tone image at the trailing end portion can be caused to fall within the visually allowable range without decreasing the opportunity to develop the electrostatic image with the toner.

### <Developing Property>

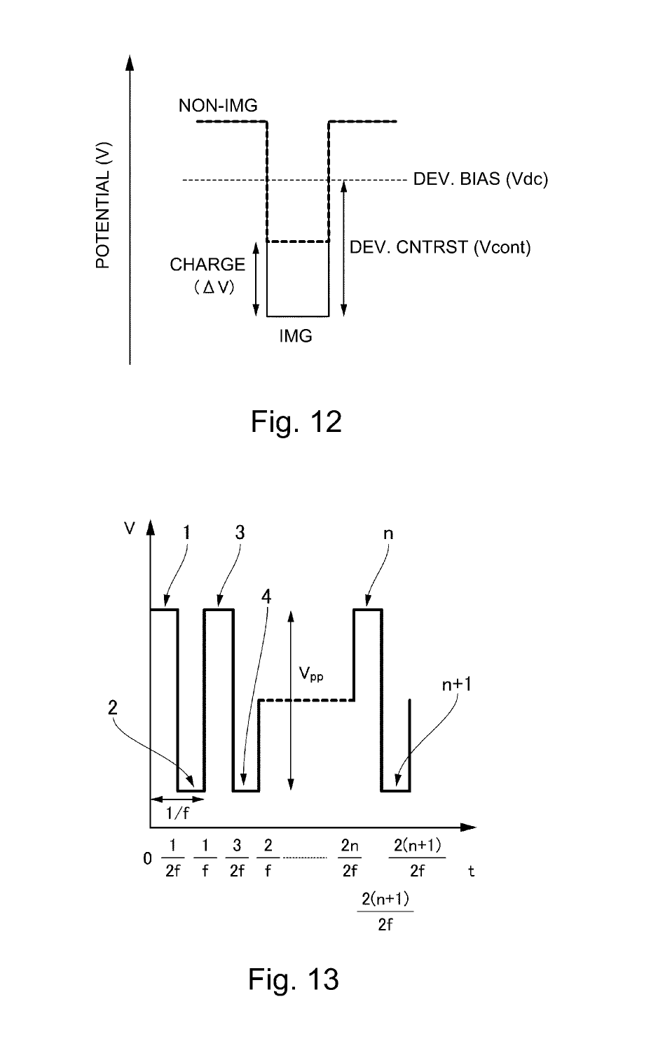

FIG. 11 is an illustration of a surface potential of the photosensitive drum before and after the development. FIG. 12 is an illustration of the developing property.

As shown in FIG. 11, Vcont represents a potential difference between a DC component of the developing bias and the high portion potential VL at a development portion of the photosensitive drum. AV represents a potential difference between the toner layer surface potential at the electrostatic image potential portion after the development and the electrostatic image potential before the development. ΔV of the photosensitive drum corresponding to the image region (solid image region) is the potential difference between the toner layer surface potential, after the development, of the light portion potential VL corresponding to the image region and the light portion potential before the development. The light portion potential VL and the toner layer surface potential were measured by a surface electrometer at the developing position or in the neighborhood of the developing position.

As shown in FIG. 12, a charging efficiency is a percentage of a charging potential ΔV to the developing contrast Vcont as shown in a formula (9) below. The developing property was evaluated by using the charging efficiency defined by the following formula (9).

(Charging efficiency)=[(charging potential ΔV)/(developing contrast Vcont)]×100(%) (9)

A measuring method of the charging efficiency will be described.

(1) First, a blank developing device in which the two-component developer is not placed is prepared, and a surface potential of the photosensitive drum 1, where the electrostatic image is not developed with the toner, after the charging and the electrostatic image formation, i.e., the electrostatic image potential before the development is measured by the surface electrometer provided immediately under the developing device.

(2) Next, a developing device in which the two-component developer is placed is prepared, and the developing bias is actually applied after the charging and the electrostatic image formation, so that the toner image is formed on the photosensitive drum 1. The photosensitive drum surface potential immediately after the development (electrostatic image potential after the development) is similarly measured by the surface electrometer.

Potential profiles of the electrostatic image potential before the development and the electrostatic image potential after the development which are obtained by the above two methods are shown in FIG. 11. As shown in FIG. 11, by subtracting the surface potential value of the electrostatic image potential before the development from that of the electrostatic image potential after the development, ΔV generated by actually developing the electrostatic image with the toner can be obtained. In this case, the percentage of ΔV to Vcont is the charging efficiency.

The developing contrast Vcont is determined at the developing position. That is, a dedicated surface electrometer is provided at the position of the developing device 4 to measure the electrostatic image potential of the developing device, and then Vdc with respect to the measured electrostatic image potential is determined to ensure Vcont at the developing position.

### <Fog>

With respect to the fog, a reflection density Ds at an image white background portion by a reflection densitometer (“SERISE1200”, mfd. by Macbeth Co.). On the other hand, a reflection density Dr of the recording material itself is similarly measured. A fog density was determined by the following formula (10).

Fog density (%)=Dr−Ds (10)

The obtained fog density was evaluated in accordance with the following evaluation criterion.

Evaluation A: 0.5% or less . . . Good

Evaluation B: 0.6% to 2% . . . Allowable

Evaluation C: more than 2% . . . Poor

### <Carrier Deposition>

The carrier deposition was evaluated as follows. When a toner image with a maximum density was formed on the photosensitive drum (solid image development) and then a main power switch was turned off, the toner image remaining on the photosensitive drum was collected by using a tape. The tape was observed through an optical microscope (mfd. by Olympus Corp.), and the number of carrier particles present in 5 cm² of the toner image was counted to calculate the number of the carrier particles per unit area.

The carrier deposition was evaluated depending on a carrier deposition number Z (particles/cm²) in accordance with the following evaluation criterion.

Evaluation A: 0.3≦Z≦ . . . Good

Evaluation B: 1<Z≦3 . . . Allowable

Evaluation C: 3<Z . . . Poor

Here, the evaluation C (poor) was a level such that the carrier transferred on the recording material and a trance of the carrier which had not been transferred onto the recording material were sufficiently recognized as a white portion remaining on the recording material as an image defect.

### <Graininess (Roughness)>

The image non-uniformity was evaluated as follows. A half-tone image (lightness L*: nearly equal 70) for which graininess is liable to be conspicuous was subjected to visual evaluation in accordance with the following evaluation criterion.

Evaluation A: Very good or good image non-uniformity

Evaluation B: Graininess is somewhat observed but is allowable

Evaluation C: Graininess is very conspicuous

### Embodiment 2

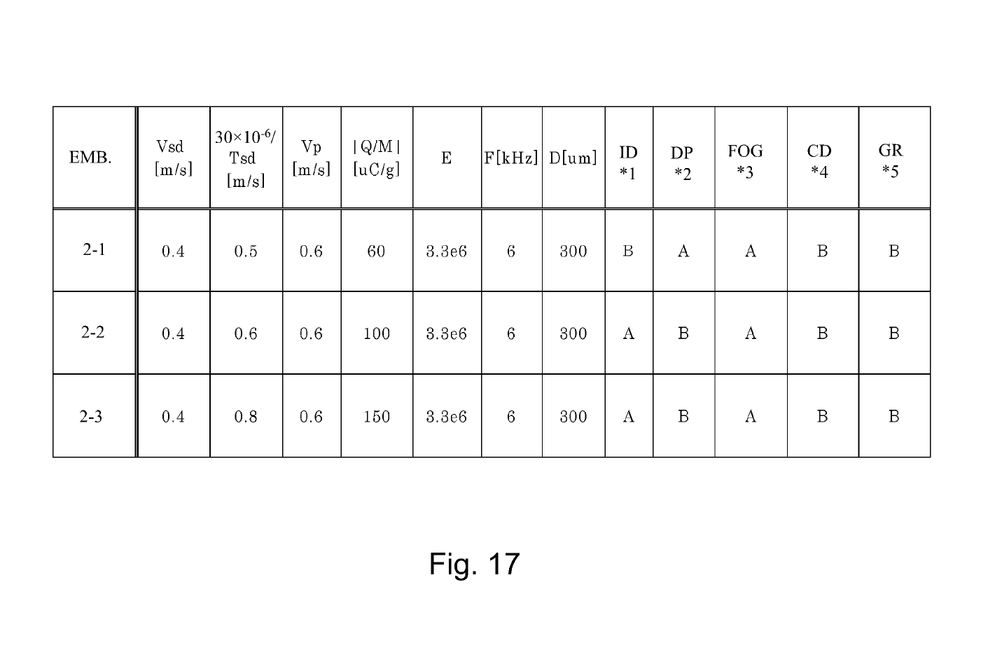

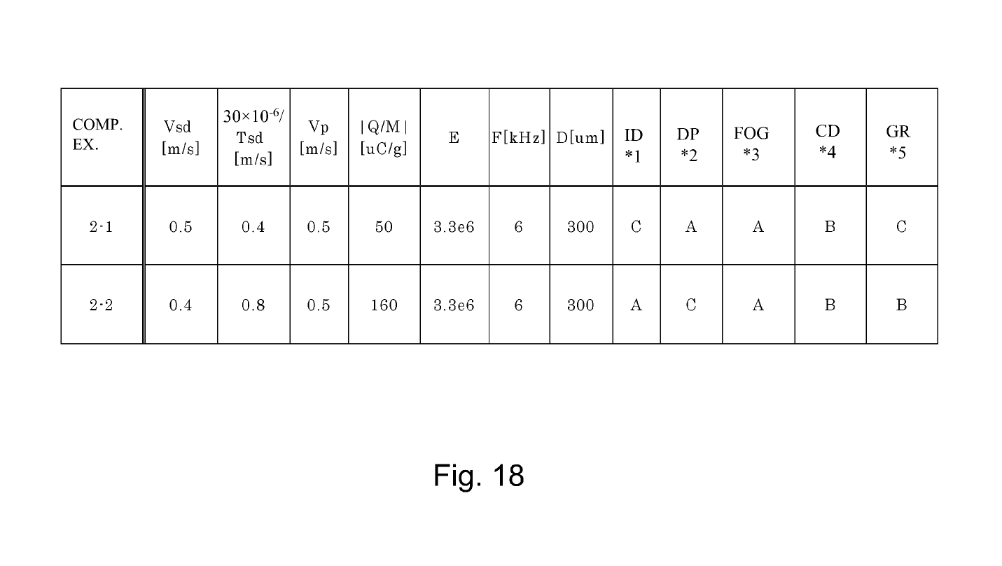

FIG. 17 is an illustration of an experimental result under an operating condition in Embodiment 2. FIG. 18 is an illustration of an experimental result under an operating condition in Comparison Example 2.

Also in Embodiment 2, similarly as in Embodiment 1, Tsd was measured by using the experimental machine for high-speed shooting, and the image was evaluated by using the image forming apparatus 100. In Embodiment 2, the respective evaluation items were measured and evaluated similarly as in Embodiment 1 by changing the toner charge amount Q/M. In order to increase and decrease the toner charge amount Q/M while keeping conditions of the toner and the carrier, a composition and mixing amount of an external additive to be added to the toner and the carrier.

As shown in FIG. 17, conditions satisfying requirements of the embodiments of the present invention are shown as Embodiments 2-1, 2-2 and 2-3. When the toner charge amount Q/M is changed, Tsd is changed. This is because followability to the applied electric field varies and influences the trailing end improper development distance. Further, when the toner charge amount is increased, an opposite electric charge generated on the carrier is also increased, and an electrostatic attraction force between the toner and the carrier is also increased. For that reason, ease of separation of the toner from the carrier is also changed and therefore as a result, the toner charge amount has the influence on the developing property.

As shown in FIG. 18, conditions which do not satisfy requirements of the embodiments of the present invention are shown as Comparison Examples 2-1 and 2-2.

Therefore, as the toner charge amount per unit weight Q/M (μC/g), a relationship: 60≦Q/M≦150 is satisfied. That is, the toner charge amount Q/M may preferably fall within a range of 60-150 μC/g.

### Embodiment 3

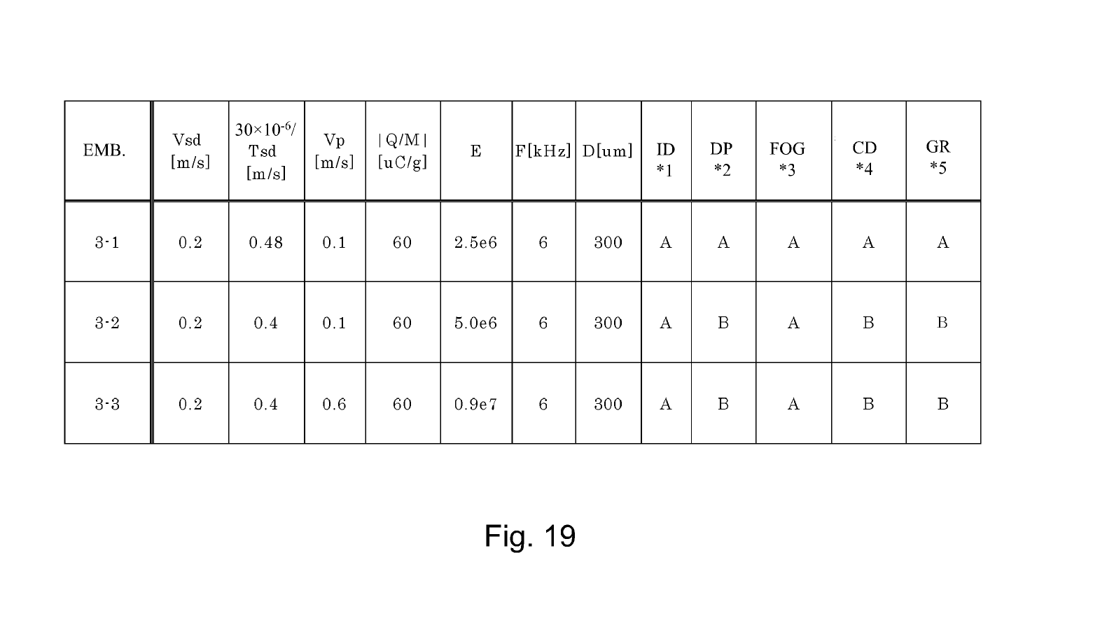

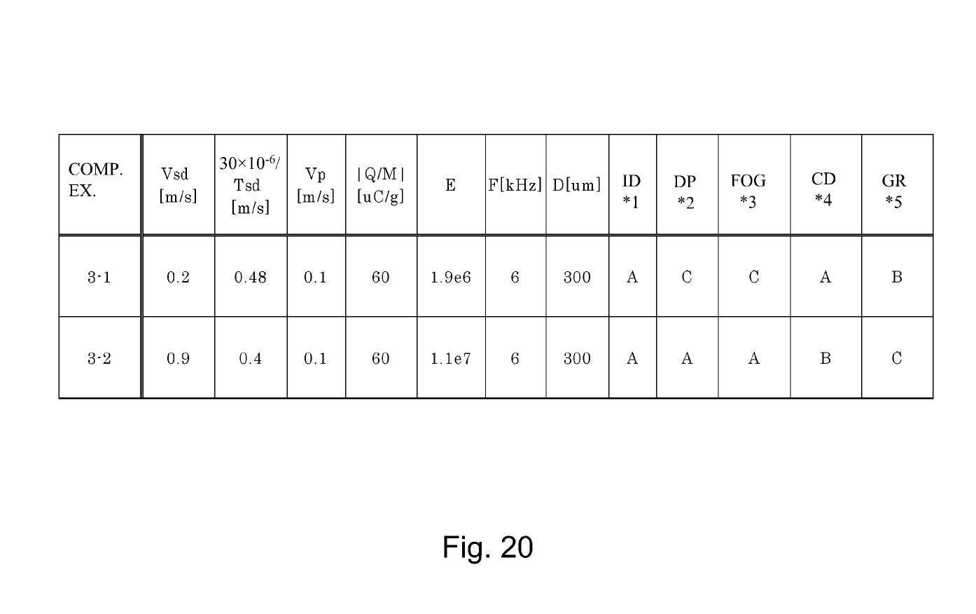

FIG. 19 is an illustration of an experimental result under an operating condition in Embodiment 3. FIG. 20 is an illustration of an experimental result under an operating condition in Comparison Example 3.

Also in Embodiment 3, similarly as in Embodiment 1, Tsd was measured by using the experimental machine for high-speed shooting, and the image was evaluated by using the image forming apparatus 100. In Embodiment 3, the respective evaluation items were measured and evaluated similarly as in Embodiment 1 by changing the field intensity applied between the developing sleeve and the photosensitive drum.

As shown in FIG. 19, conditions satisfying requirements of the embodiments of the present invention are shown as Embodiments 3-1, 3-2 and 3-3. When the field intensity is changed, a movement speed of toner particles having the same toner charge amount Q/M is changed and thus also Tsd is changed, and therefore the trailing end improper development distance is changed. When the field intensity is high, a force for separating the toner from the carrier is also strengthened. For this reason, also the developing property is improved but when metal powder or the like is included, there is such a harmful effect that electric discharge is induced and thus the photosensitive layer is deteriorated. For that reason, it is undesirable that the field intensity is increased endlessly.

As shown in FIG. 20, conditions which do not satisfy requirements of the embodiments of the present invention are shown as Comparison Examples 3-1 and 3-2.

Therefore, when a maximum field intensity by a predetermined AC voltage in a direction toward the photosensitive drum 1 is E (V/m), the maximum field intensity E satisfied a relationship: 2.0×10⁶≦E≦1.0×10⁷. An AC component of the developing bias may preferably be 0.2×10⁻⁷ to 1.0×10⁻⁷ (V/m). This range of the field intensity E is irrespective of the developing electric field and the pull-back electric field.

### <Other Parameters>

In either of Embodiments 1, 2 and 3, by lowering the frequency of the developing bias, it is possible to increase the movement distance of the toner in one period of the developing bias, so that the trailing end improper development distance can be shortened. However, it is known that a low-frequency developing bias worsen the image defect which is called “fog” such that the toner is deposited on the non-image portion, so that the frequency cannot be lowered endlessly.

A frequency (f) of a proper developing bias varies, according to a result of study by the present inventors, depending on selected toner and carrier but may preferably fall within the following range of a formula (11).

3≦f≦9 (kHz) (11)

Therefore, when the frequency of a predetermined AC voltage is f (kHz), the frequency of satisfies a relationship: 3 (kHz)≦f≦9 (kHz).

Further, a distance in which the toner is required to be moved is shortened by decreasing the closest distance between the developing sleeve and the photosensitive drum and therefore the time Tsd required until the toner reaches the photosensitive drum is shortened and thus also the trailing end improper development distance is shortened. However, correspondingly, the field intensity between the developing sleeve and the photosensitive drum is strengthened. Therefore, similarly for the reason why the field intensity range is defined, the electric discharge at the developing portion becomes conspicuous unpreferably.

The proper closest distance D between the developing sleeve and the photosensitive drum varies, according to a result of study by the present inventors, depending on a depositing force between selected toner and carrier but may preferably fall within the following range of a formula (12).

250≦D≦450 (μm)

Therefore, when an opposing distance of a predetermined gap is D (μm), the opposing distance D satisfies a relationship: 250≦D≦450 (μm).

### <Calculation of Tsd by Simple Model>

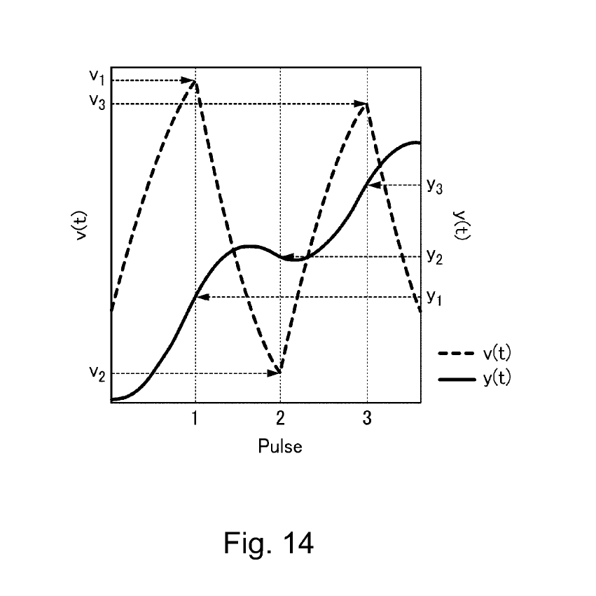

FIG. 13 is an illustration of the developing bias. FIG. 14 is an illustration of a locus of toner particle obtained by model calculation.

In Embodiments 1, 2 and 3, by using the actually measured value of the time Tsd, the range in which the trailing end improper development was not substantially generated and the above-described other evaluation items were also satisfied was defined. However, it would be considered that the trailing end improper development distance D cannot be accurately controlled when it is uncertain that the time Tsd required until the toner reaches the photosensitive drum 1 is dominated by what device parameter. Therefore, in the following, in order to support the data in FIGS. 15 to 20 and to replenish a missing data range in FIGS. 15 to 20, a simple model was set and then Tsd was calculated. The toner behavior was described by using the simple model and from its result, a parameter which dominated the time Tsd was extracted.

As shown in FIG. 8, the locus of the toner T, which is separated from the carrier and then is moved, with respect to y direction of the photosensitive drum 1 can be described by using an equation of motion of a formula (13) below. In this equation of motion, the first term of the right side represents a force exerted from the electric field, and the second term of the right side represents air resistance.

$$m \frac{d v}{d t} = qE - 6 π η rv \qquad ( 13 )$$

m: toner weight (kg)

q: toner charge amount (C)

E: field intensity applied between developer carrying member and image bearing member (V/m)

r: toner radius (m)

v: toner speed in y direction (m/sec)

η: 1.82×10⁻⁵ (Pa·sec)

From the above equation of motion of the formula (13), when the toner speed v(t) and a position y(t) at an arbitrary time (t) are obtained, the following two formulas (14) and (15) are obtained.

$$\begin{matrix}{v}_{y} ( t ) = \frac{qE}{6 π η r} + ( {v}_{0} - \frac{qE}{6 π η r} ) exp ( - \frac{6 π η r}{m} t ) & ( 14 ) \\ y ( t ) = {y}_{0} + \frac{qE}{6 π η r} t + \frac{m}{6 π η r} ( {v}_{0} - \frac{qE}{6 π η r} ) ( 1 - exp ( - \frac{6 πη r}{m} ) ) & ( 15 )\end{matrix}$$

f: frequency (Hz) of AC voltage Vac

m: toner weight (kg)

q: toner charge amount (C)

E: field intensity applied between developer carrying member and image bearing member (V/m)

r: toner radius (m)

y₀: distance from developer carrying member at t=0 (m)

v₀: toner speed in y direction at t=0 (m/sec)

D: distance between developer carrying member and image bearing member (m)

η: 1.82×10⁻⁵ (Pa·sec)

As shown in FIG. 13, the developing bias includes an AC component of rectangular wave and therefore depending on switching of peak, the field intensity E in the formulas (14) and (15) are changed. That is, the formulas (14) and (15) are applicable to only a half period of the developing bias.

In a subsequent half period after the peak is switched, it is required that the field intensity E is switched and as the initial position y₀ and speed v₀ of the toner, those in a final state in the preceding half period are used. That is, the formulas (14) and (15) are required to be used in a recurrence manner, thus requiring attention. Further, the number of pulses of the AC voltage Vac is that in the half period.

As shown in FIG. 13, the polarity of the AC voltage pulse is inverted every one increase in the number of pulses (n). As shown in FIG. 8, the toner particle is driven by the developing contrast while being influenced by the polarity inversion of the AC voltage pulse, thus being moved from the developing sleeve to the photosensitive drum.

As shown in FIG. 14, a distance of the toner from the developing sleeve and a toner speed after the pulse of the AC voltage Vac is applied one time are y₁ and v₁, respectively. In this case, when a second-time pulse is applied, a toner speed v₂(t) and a toner position y₂(t) are represented by the following formulas (16) and (17).

$$\begin{matrix}{v}_{2} ( t ) = \frac{qE}{6 π η r} + ( {v}_{1} - \frac{qE}{6 π η r} ) exp ( - \frac{6 π η r}{m} t ) & ( 16 ) \\ {y}_{2} ( t ) = {y}_{1} + \frac{qE}{6 π η r} t + \frac{m}{6 π η r} ( {v}_{1} - \frac{qE}{6 π η r} ) ( 1 - exp ( - \frac{6 π η r}{m} t ) ) & ( 17 )\end{matrix}$$

As shown in FIG. 14, when toner speed and position at the time when the application of the second-time pulse is ended are v₂ and y₂, respectively, a toner speed v₃(t) and a toner position y₃(t) during third-time pulse application are represented by the following formulas (18) and (19).

$$\begin{matrix}{v}_{3} ( t ) = \frac{qE}{6 π η r} + ( {v}_{2} - \frac{qE}{6 π η r} ) exp ( - \frac{6 π η r}{m} t ) & ( 18 ) \\ {y}_{3} ( t ) = {y}_{2} + \frac{qE}{6 πη r} t + \frac{m}{6 π η r} ( {v}_{2} - \frac{qE}{6 π η r} ) ( 1 - exp ( - \frac{6 πη r}{m} t ) ) & ( 19 )\end{matrix}$$

Therefore, when toner speed and position at the time when the application of (n−1)-th pulse is ended are vₙ₋₁ and yₙ₋₁, respectively, a toner speed vₙ(t) and a toner position yₙ(t) during n-th pulse application can be generalized and represented by the following formulas (20) and (21).

$$\begin{matrix}{v}_{n} ( t ) = \frac{qE}{6 πη r} + ( {v}_{n - 1} - \frac{qE}{6 πη r} ) exp ( - \frac{6 πη r}{m} t ) & ( 20 ) \\ {y}_{n} ( t ) = {y}_{n - 1} + \frac{qE}{6 π η r} t + \frac{m}{6 πη r} ( {v}_{n - 1} - \frac{qE}{6 πη r} ) ( 1 - exp ( - \frac{6 π η r}{m} t ) ) & ( 21 )\end{matrix}$$

Thus, the field intensity is changed with the polarity inversion of the applied pulse, and therefore attention should be paid in that the field intensity E is required to be calculated every applied pulse. The field intensity E of the AC voltage Vac is specifically represented by the following formula (22) in which two cases are separately described.

$$E = \{ \begin{matrix}\frac{( \frac{{V}_{pp}}{2} + {V}_{d c} ) - {V}_{t}}{D} \\ \frac{( - \frac{{V}_{pp}}{2} + {V}_{d c} ) - {V}_{t}}{D}\end{matrix} \qquad ( 22 )$$

The upper formula in the formula (22) represents a field intensity for moving the toner from the developing sleeve to the photosensitive drum. The lower formula in the formula (22) represents a field intensity for pulling-back the toner from the photosensitive drum to the developing sleeve.

As shown in FIG. 6, at the point A on the developing sleeve 41, the toner opposes the non-image region on the photosensitive drum 1 and therefore is attracted toward the developing sleeve 41 by the electrostatic force. At the point A shown in FIG. 7, the toner catches up with the electrostatic image S indicated by a broken line and at an instance when the toner opposes the electrostatic image S, the toner is moved toward the opposing point B on the photosensitive drum 1 in accordance with the formula (15).

The time Tsd represents a time required until the toner position with respect to y direction becomes equal to the closest position between the developing sleeve and the photosensitive drum. Assuming that during application of the n-th pulse of the developing bias AC voltage, the toner position with respect to y direction becomes equal to the closest position between the developing sleeve and the photosensitive drum after a lapse of the time Tsd from the n-th pulse application, the following formula (23) is satisfied.

$$\begin{matrix}{y}_{n} ( {t}_{sd} ) = {y}_{n - 1} + \frac{qE}{6 π η r} {t}_{sd} + \\ \frac{m}{6 π η r} ( {v}_{n - 1} - \frac{qE}{6 π η r} ) ( 1 - exp ( - \frac{6 πη r}{m} {t}_{sd} ) ) \\ = D\end{matrix} \qquad ( 23 )$$

q: toner charge amount (C)

m: toner weight (kg)

r: toner radius (m)

f: frequency of AC voltage Vac (Hz)

E: field intensity applied between developer carrying member and image bearing member (V/m)

D: distance between developer carrying member and image bearing member (m)

Here, attention is paid to separate description between Tsd and tsd. The time Tsd is the sum of the time tsd from the n-th pulse application until the toner reaches the photosensitive drum and a time from start of movement of the toner from the developing sleeve surface, i.e., from the first pulse application until the toner reaches the photosensitive drum. The time tsd in the formula (23) is the time with respect to the n-th pulse and therefore in order to calculate the time Tsd, there is a need to add the time tsd with respect to the n-th pulse to the sum of the times with respect to the pulses from the first pulse to the (n−1)-th pulse. The time with respect to one pulse is ½ of the time of one period, i.e., ½f and therefore the time Tsd can be represented by the following formula (24).

$${T}_{sd} = {t}_{sd} + \frac{n - 1}{2 f} \qquad ( 24 )$$

The distance X given by the formula (7) in which the toner catches up with the electrostatic image is equal to the trailing end improper development distance X in the model in this embodiment. Therefore, when the peripheral speed difference Vsd between the developing sleeve and the photosensitive drum and the time Tsd required until the toner reaches the photosensitive drum are decreased, the trailing end improper development distance X can be shortened as described above.

### <Tone Charge Amount>

Measuring methods of the toner charge amount Q/M, the toner weight and the toner particle size which are parameters for specifically determining the time Tsd will be described.

The charge amount and particle size of the toner were measured by using a copying machine (“CLC5000”, mfd. by Canon K.K.) and a measuring device (“E-SPART Analyzer”, mfd. by Hosokawa Micron Group). The toner is used for developing the electrostatic image on the photosensitive drum and thereafter is transferred onto the recording material P, which is then conveyed to the fixing device 6. In this embodiment, the charge amount Q/M and particle size of the toner actually used for developing the electrostatic image on the photosensitive drum were measured and therefore before the toner was transferred onto the recording material P, the electric power of the image forming apparatus 100 was turned off and then the toner was collected every photosensitive drum.

Next, the photosensitive drum on which the electrostatic image is developed with the toner is set on a measuring table of the measuring device (“E-START Analyzer”), and nitrogen gas is blown onto the toner on the photosensitive drum to remove the toner from the photosensitive drum, and then the toner is passed between flat plate electrodes to which the electric field is applied.

When a toner charge amount is qi, a toner particle size is di, a viscosity coefficient of air is η, the field intensity is E, and a movement speed of the toner particle to the electrodes is vi, on the assumption that a force exerted on a sphere in a viscous fluid (i.e., Stokes drag) and an electrostatic force are equal to each other, the following formula (25) is satisfied with respect to each toner particle.

$${q}_{i} = \frac{3 π η {d}_{i}}{E} v \qquad ( 25 )$$

Further, a sound wave is applied to the toner, so that the toner vibrates at a frequency of the sound wave. In this case, the toner particle is irradiated with two laser beams so as to cross each other, and by laser Doppler method, a beat frequency and a vibration phase delay of the toner are measured.

In the laser Doppler method, when the generated beat frequency is Δf, a laser wavelength is λ, a crossing angle between the two laser beams is θ, and an elevation angle of the laser beam from the horizontal surface is Ψ, the following formula (26) is satisfied with respect to each toner particles.

$${v}_{i} = \frac{λΔ f}{2 sin θ \cdot cos ψ} \qquad ( 26 )$$

Further, when the vibration phase delay of the toner is φ and the sound wave frequency is ω, the following formula (27) is satisfied.

$$φ = {tan}^{- 1} ( \frac{{d}^{2}}{18 η} ω ) \qquad ( 27 )$$

From the beat frequency Δf, by the formula (26), the movement speed vi of each toner is calculated. From the vibration phase delay φ of each toner, by the formula (27), the particle size di of each toner is calculated. By substituting the movement speed vi and the particle size di in the formula (25), the charge amount qi of each toner is obtained. The weight mi of each toner is converted from the particle size di and a density.

In this embodiment, with respect to each of 3000 toner particles, the particle size di, the charge amount qi and the weight mi were obtained. A volume average of an average particle size D50 of the measured 3000 toner particles was determined as a particle size d. Further, number averages of the charge amount qi and the weight mi of the measured 3000 toner particles were determined as a toner charge amount q and a toner weight m, respectively.

Further, in FIGS. 15 to 20, the toner charge amount per unit weight Q/M refers to a number average of values each obtained by dividing the charge amount q by the weight m. Further, the particle size d, the charge amount q and the weight m which are measured by the above-described measuring methods are the same as those in the formulas (13) to (21) and (23).

### Embodiment 4

The present invention is described above based on specific embodiment but it should be understood that the present invention is not limited to the above-described embodiments and specific examples. For example, in the above-described embodiments and specific examples, the photosensitive drum was described such that it is negatively charged and the electrostatic image is formed on the photosensitive drum by the image exposure system. However, the present invention is not limited thereto but the charge polarity of the photosensitive drum may also be positive. Further, the electrostatic image may also be formed on the photosensitive drum by a background exposure system in which exposure is effected at the non-image portion where the toner should not be deposited. Further, as the developing system, a normal development system in which the toner charged to a polarity identical to the charge polarity of the photosensitive drum is used, i.e., the electrostatic image is developed at the image portion where the photosensitive drum is not exposed to light may also be used.

In the non-contact development, a phenomenon, which is so-called downstream concentration, such that the density at the trailing end portion is increased was conventionally problematic. This is attributable to the influence of wrap-around of the electric field generated in the gap between the developing sleeve and the photosensitive drum. However, with the toner deterioration and the increase in process speed in recent years, the decrease in density at the trailing end portion is rather problematic.

On the other hand, in JP-A 2003-323051, the method for alleviating the density lowering by controlling the magnetic chain by the arrangement of the magnetic poles is proposed. That is, an auxiliary magnetic pole is provided adjacent the main magnetic pole and an angle of the auxiliary magnetic pole is set with a proper range, so that a region where the magnetic chain contacts the image bearing member is narrowed. As a result, the toner once used for developing the electrostatic image is caused not to be readily collected by the electric charge of the carrier opposite to that of the toner.

However, by narrowing the developing region, also the developing opportunity is lost and therefore it becomes difficult to compatibly realize the density lowering alleviation and the developing property, thus being insufficient. As described above, the trailing end improper development is caused by the following two reasons.

(1) A first reason is such that the toner once used for developing the electrostatic image is removed by the counter charge of the carrier.

(2) A second reason is the presence of the peripheral speed difference between the developing sleeve and the photosensitive drum. In the conventional image forming apparatus, the process speed is not high compared with that of a current image forming apparatus and therefore the trailing end improper development due to the peripheral speed difference is not problematic. However, with the speed-up of the process speed in recent years, the peripheral speed difference is increased, so that the problem of the trailing end improper development becomes conspicuous. In JP-A 2003-323051, a countermeasure to the first reason was taken but is not sufficient, and no countermeasure to the second reason was taken.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 032551/2012 filed Feb. 17, 2012, which is hereby incorporated by reference.

What is claimed is:

1. An image forming apparatus comprising:
an image bearing member;
an electrostatic image forming device for forming an electrostatic image on said image bearing member; and
a developer carrying member for carrying a developer magnetically attracted on its surface to a developing position where said developer carrying member opposes said image bearing member, wherein said developer carrying member is provided so as to be rotated in a direction opposite to a rotational direction of said image bearing member at a peripheral speed higher than that of said image bearing member,
wherein when the peripheral speed of said image bearing member is Vp (m/sec), the peripheral speed of said developer carrying member is Vs (m/sec), and a time, of movement of the developer from the surface of said developer carrying member to said image bearing member, actually measured in a gap between said image bearing member and said developer carrying member is Tsd (sec), the peripheral speeds Vp and Vs and the time Tsd satisfy the following relationship:
(Vs−Vp)−Tsd<3×10⁵ (m).

2. An image forming apparatus according to claim 1, wherein the peripheral speed Vp is 0.1 (m/sec) or more and 0.5 (m/sec) or less, and the peripheral speeds Vp and Vs satisfy the following relationship:
0.2 (m/sec)<(Vs−Vp)<0.5 (msec).

3. An image forming apparatus according to claim 1, further comprising a voltage source for applying to said developer carrying member an oscillating voltage in the form of a predetermined DC voltage biased with a predetermined AC voltage, and
wherein when a frequency of the predetermined AC voltage is f (kHz), a maximum field intensity in a direction in which a toner is moved toward said image bearing member by the predetermined AC voltage is E (V/m), and a toner charge amount per unit weight is Q/M (μC/g), the frequency f, the maximum field intensity E and the toner charge amount Q/M satisfy the following relationships:
3 (kHz)≦f≦9 (kHz),
2.0×10⁶ (V/m)≦E≦1.0×10⁷ (V/m), and
60 (μC/g)≦Q/M≦150 (μC/g).

4. An image forming apparatus according to claim 1, wherein when the gap between said image bearing member and said developer carrying member has an opposing distance is D (μm), the opposing distance satisfies the following relationship:
250 (μm)<D<450 (μm).

5. An image forming apparatus according to claim 1, wherein said developer carrying member develops the electrostatic image by rubbing said image bearing member with a magnetic chain of the developer containing a toner and a carrier.
